(19) United States
(12) Patent Application Publication
(10) Pub. No.: US 2026/0175211 A1
(43) Pub. Date: Jun. 25, 2026

(54) CATALYST REGENERATION EQUIPMENT AND CATALYST REGENERATION METHOD

(71) Applicant: HONDA MOTOR CO., LTD., Tokyo (JP)

(72) Inventor: Hideaki SUMI, Saitama (JP)

(21) Appl. No.: 19/424,327

(22) Filed: Dec. 18, 2025

(30) Foreign Application Priority Data
Dec. 23, 2024 (JP) 2024-226479

(51) Int. Cl. B01J 38/06; B01J 38/10; B01J 38/12

(52) U.S. Cl. CPC B01J 38/06; B01J 38/10; B01J 38/12

(57) ABSTRACT

Catalyst regeneration equipment for regenerating a catalyst that has been degraded due to a catalytic action, while a predetermined source gas is being continuously introduced, in a reactor including a plurality of reaction tubes each being filled with the catalyst, the reactor generating a predetermined product through the catalytic action of the catalyst in each of the plurality of reaction tubes, the catalyst regeneration equipment including: a catalyst degradation detection unit configured to detect presence or absence of degradation of the catalyst in every one of the plurality of reaction tubes; a regeneration gas supply unit capable of supplying a predetermined regeneration gas for regenerating a degraded catalyst to every one of the plurality of reaction tubes; and a controller configured to control the regeneration gas supply unit to supply the regeneration gas to a reaction tube including the catalyst in which the degradation has been detected, based on a detection result by the catalyst degradation detection unit.

### BACKGROUND

### Technical Field

The present invention relates to catalyst regeneration equipment and a catalyst regeneration method to be applied to a manufacturing apparatus in which a predetermined source gas is introduced into a reactor that accommodates a catalyst to manufacture a predetermined product through a catalytic action, and to regenerate a degraded catalyst due to the catalytic action.

### Related Art

In general, when hydrocarbons are produced by Fischer-Tropsch (FT) reaction, carbon is precipitated and deposited on the surface of a catalyst for performing the FT reaction (hereinafter, referred to as “FT catalyst” in the present column), that is, so-called coking, and the catalyst performance of the FT catalyst is degraded. Hence, the FT catalyst may be degraded. In order to solve such degradation of the FT catalyst, an FT reaction apparatus disclosed in JP 2022-102703 A has been conventionally known as a hydrocarbon manufacturing apparatus having a regeneration function for enhancing its catalyst performance for a degraded FT catalyst. Such an FT reaction apparatus includes a first reactor and a second reactor, and an FT catalyst is accommodated in both reactors.

When manufacturing hydrocarbons in the FT reaction apparatus, while supplying the first and second reactors with the source gas containing carbon monoxide and hydrogen, by causing an FT reaction in each reactor, the hydrocarbons are manufactured. In addition, in regenerating the degraded FT catalyst in the FT reaction apparatus, the supply of the source gas to one of the first and second reactors is continued, whereas the supply of the source gas to the other one of the first and second reactors is stopped, and a regeneration treatment of the FT catalyst in the reactor is conducted. In such a regeneration treatment, the reactor containing the FT catalyst that should be regenerated is heated so that the temperature of the FT catalyst reaches 300 to 400 degrees Celsius, and in addition, oxygen is supplied to burn the carbon deposited on the surface of the FT catalyst. Then, the supply of oxygen is stopped, and hydrogen is supplied for reduction. In the above regeneration treatment, by removing the carbon from the degraded FT catalyst, the FT catalyst is regenerated. As described heretofore, in the FT reaction apparatus, while hydrocarbons are continuously manufactured in at least one of the first and second reactors, the regeneration treatment of the FT catalyst is alternately conducted between both reactors, and thus the FT catalyst in each reactor is regenerated.

### CITATION LIST

### Patent Literature

Patent Literature 1: JP 2022-102703 A

### SUMMARY

In the above FT reaction apparatus, as described above, in conducting the regeneration treatment of the FT catalyst, the source gas is continuously supplied to one of the first and second reactors to continuously manufacture the hydrocarbons, but the supply of the source gas to the other reactor is stopped. Hence, manufacturing of the hydrocarbons is stopped in the other reactor during such a period of time. For this reason, in the above FT reaction apparatus, while the regeneration treatment of the FT catalyst is being conducted, the manufacturing amount of hydrocarbons is reduced by half, and the manufacturing efficiency decreases largely.

The present invention has been made to solve the above problem, and an object of the present invention is to provide catalyst regeneration equipment and a catalyst regeneration method that are capable of regenerating a degraded catalyst while suppressing a decrease in manufacturing efficiency at the time of manufacturing a predetermined product.

In order to achieve the above object, in the invention according to claim 1, catalyst regeneration equipment (product manufacturing apparatus 1 in an embodiment (hereinafter, described in a similar manner in the present claim)) for regenerating a catalyst C that has been degraded due to a catalytic action, while a predetermined source gas is being continuously introduced, in a reactor 3 including a plurality of reaction tubes 2 each being filled with the catalyst, the reactor generating a predetermined product through the catalytic action of the catalyst in each of the plurality of reaction tubes, the catalyst regeneration equipment characterized by including: a catalyst degradation detection unit (a temperature sensor 4) configured to detect presence or absence of degradation of the catalyst in every one of the plurality of reaction tubes; a regeneration gas supply unit 6 capable of supplying a predetermined regeneration gas for regenerating a degraded catalyst to every one of the plurality of reaction tubes; and a controller 7 configured to control the regeneration gas supply unit to supply the regeneration gas to a reaction tube including the catalyst in which the degradation has been detected, based on a detection result by the catalyst degradation detection unit.

According to this configuration, in the reactor including the plurality of reaction tubes each being filled with the catalyst, the predetermined product is produced by the catalytic action of the catalyst in each reaction tube, while the predetermined source gas is being introduced. In this case, the catalyst performance of the catalyst in each reaction tube may be lowered and degraded due to the catalytic action. In the above reactor, the following regeneration treatment is conducted to regenerate the degraded catalyst so as to enhance the catalyst performance, while the source gas is being continuously introduced.

That is, first, the catalyst degradation detection unit detects presence or absence of the degradation of the catalyst in each of the plurality of reaction tubes. Then, the regeneration gas supply unit supplies a predetermined regeneration gas for regenerating the catalyst to the reaction tube including the catalyst in which the degradation has been detected. That is, in the reactor including the plurality of reaction tubes, the regeneration gas is supplied in a pinpointed manner to the reaction tube including the catalyst in which the degradation has been detected. This enables regeneration of the degraded catalyst of the catalysts accommodated in the reactors in a pinpointed manner, while the products are being continuously manufactured by the source gas that is continuously introduced into the reactor. In this manner, according to the present invention, it becomes possible to regenerate the degraded catalyst while suppressing a decrease in manufacturing efficiency at the time of manufacturing a predetermined product.

According to the invention of claim 2, in the catalyst regeneration equipment described in claim 1, the catalyst degradation detection unit is characterized by including a plurality of temperature sensors 4 respectively provided in the plurality of reaction tubes, and configured to respectively detect temperatures of the catalysts in the plurality of reaction tubes.

According to this configuration, a plurality of temperature sensors as the catalyst degradation detection units are respectively provided in the plurality of reaction tubes, and the temperature of the catalyst in the corresponding reaction tube is detected by each temperature sensor. For example, when the temperature of the catalyst largely deviates from an appropriate temperature at the time of the catalytic action, an appropriate catalytic action is not obtainable. Thus, it becomes possible to determine that the catalyst is degraded. Therefore, by providing the temperature sensor in each of the plurality of reaction tubes, and detecting the temperature of the catalyst in every reaction tube, it becomes possible to determine the degradation of the catalyst.

According to the invention of claim 3, in the catalyst regeneration equipment described in claim 2, characterized in that each of the plurality of reaction tubes is configured to extend between an upstream side and a downstream side of the reactor, and the plurality of temperature sensors each include a plurality of sensor elements 4a disposed to be spaced apart at a predetermined interval from each other along a length direction of each of the plurality of reaction tubes.

According to this configuration, each reaction tube extends between the upstream side and the downstream side of the reactor, and the temperature sensor provided in each reaction tube includes the plurality of sensor elements disposed to be spaced apart at a predetermined interval from each other along the length direction of the reaction tube, so that the temperatures of the catalyst can be detected in a plurality of positions in the length direction of the reaction tube. This makes it possible to finely determine the degradation degree of the catalyst in the length direction of the reaction tube that corresponds to the flow direction of the source gas.

According to the invention of claim 4, in the catalyst regeneration equipment described in claim 2, characterized in that the controller is configured to be capable of adjusting a flow rate of the regeneration gas supplied by the regeneration gas supply unit.

According to this configuration, the controller controls the regeneration gas supply unit, and thus the flow rate of the regeneration gas to be supplied is adjustable. Thus, it becomes possible to adjust the flow rate of the regeneration gas appropriately in accordance with the degradation degree or the like of the catalyst that should be regenerated.

According to the invention of claim 5, in the catalyst regeneration equipment described in claim 4, characterized in that the controller adjusts and increases the flow rate of the regeneration gas, as a deviation Td between an appropriate temperature (appropriate temperature Ta) of the catalyst when the predetermined product is produced and the temperature (detection temperature Tc) that has been detected by the temperature sensor increases.

In general, as the deviation between the proper temperature of the catalyst at the time of producing the product and the temperature that has been detected by the temperature sensor increases, the degradation degree of the catalyst increases. Therefore, according to the present invention, by adjusting and increasing the flow rate of the regeneration gas, as the degradation degree of the catalyst increases, it becomes possible to regenerate the catalyst appropriately in accordance with the degradation degree of the catalyst.

According to the invention of claim 6, in the catalyst regeneration equipment described in claim 1, characterized in that the plurality of reaction tubes are each configured to extend between an upstream side and a downstream side of the reactor, and are disposed radially from a central portion of the reactor, and the regeneration gas supply unit includes: a plurality of ring-shaped supply tubes (a second supply pipe 32 and a third supply pipe 33) disposed on the upstream side of the plurality of reaction tubes in the reactor, and configured to be concentric around a central portion of the reactor; and a plurality of discharge ports 32a and 33a respectively disposed in the plurality of ring-shaped supply pipes along a circumferential direction, and configured to discharge the regeneration gas respectively to the plurality of reaction tubes.

According to this configuration, the plurality of reaction tubes each extending between the upstream side and the downstream side of the reactor are disposed radially from the central portion of the reactor. Further, the regeneration gas supply unit includes a plurality of ring-shaped supply tubes disposed on the upstream side of the plurality of reaction tubes in the reactor, and these ring-shaped supply tubes are configured to be concentric around the central portion of the reactor. In addition, in each ring-shaped supply tube, a plurality of discharge ports for discharging the regeneration gas to the corresponding reaction tube are disposed along the circumferential direction. When the source gas is introduced into the reactor including the reaction tubes disposed as described above, the degrees of degradation may be similar to each other in the catalysts in the plurality of reaction tubes each having the same distance from the central portion of the reactor. Therefore, by flowing the regeneration gas into the ring-shaped supply tubes, the regeneration gas can be simultaneously supplied to the plurality of reaction tubes, which are respectively disposed at equal distances from the central portion of the reactor through the plurality of discharge ports of the ring-shaped supply tubes, so that the catalysts in these reaction tubes can be efficiently regenerated.

In the invention according to claim 7, a catalyst regeneration method for regenerating a catalyst C that has been degraded due to a catalytic action, while a predetermined source gas is being continuously introduced, in a reactor 3 including a plurality of reaction tubes 2 each being filled with the catalyst, the reactor generating a predetermined product through the catalytic action of the catalyst in each of the plurality of reaction tubes, the catalyst regeneration method characterized by including: a catalyst degradation determination process of determining presence or absence of degradation of catalysts in the plurality of reaction tubes; and a catalyst regeneration process of supplying a predetermined regeneration gas for regenerating a degraded catalyst to a reaction tube including the catalyst in which the degradation has been detected.

According to this configuration, the catalyst that has been degraded due to the catalytic action is regenerated, while the source gas is being continuously introduced into the reactor. Specifically, first, presence or absence of the catalyst degradation in the plurality of reaction tubes in the reactor is determined (the catalyst degradation determination process). Then, a predetermined regeneration gas is supplied to the reaction tube including the catalyst in which the degradation has been determined (the catalyst regeneration process). That is, in the reactor including the plurality of reaction tubes, the regeneration gas is supplied in a pinpointed manner to the reaction tube including the catalyst in which the degradation has been detected. This enables regeneration of the degraded catalyst of the catalysts accommodated in the reactors in a pinpointed manner, while the products are being continuously manufactured by the source gas that is continuously introduced into the reactor. In this manner, according to the present invention, it becomes possible to regenerate the degraded catalyst while suppressing a decrease in manufacturing efficiency at the time of manufacturing a predetermined product.

### BRIEF DESCRIPTION OF DRAWINGS

FIGS. 1A and 1B are views for describing a reactor of a product manufacturing apparatus to which catalyst regeneration equipment according to one embodiment of the present invention is applied, in which FIG. 1A is a longitudinal cross-sectional view of the reactor, and FIG. 1B is a transverse cross-sectional view of the reactor;

FIG. 2 is a block diagram of a product manufacturing apparatus;

FIG. 3 is a flowchart at the time of manufacturing a product in the product manufacturing apparatus;

FIG. 4 is a diagram for describing a regeneration mode of a catalyst in the reactor at the time of manufacturing the product;

FIGS. 5A-5D are diagrams for describing the supply of a regeneration gas; and

FIG. 6 is a diagram for describing one example of a supply pipe of the regeneration gas.

### DETAILED DESCRIPTION

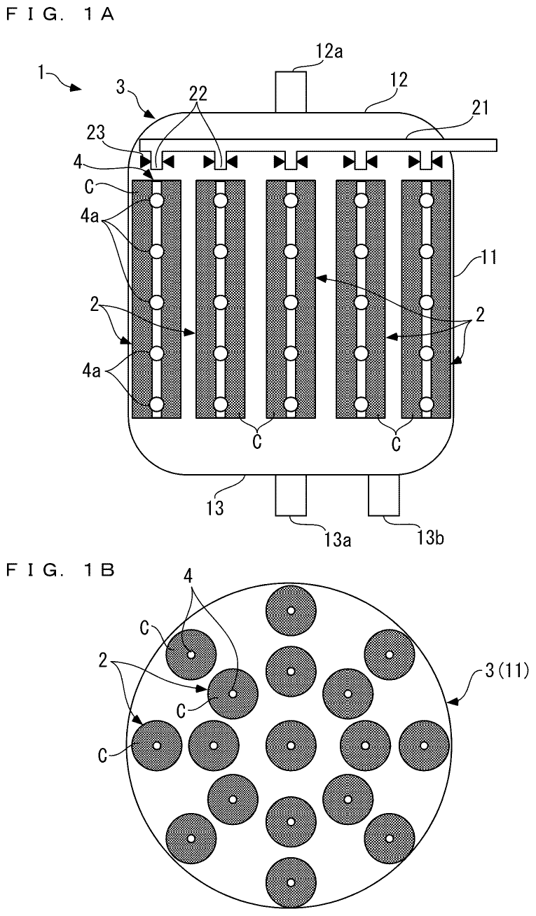

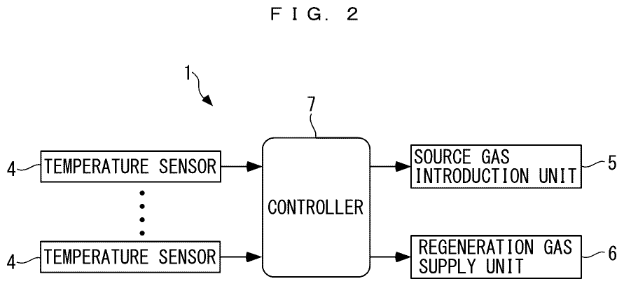

Hereinafter, preferred embodiments of the present invention will be described in detail with reference to the drawings. FIGS. 1A and 1B illustrate a reactor in a product manufacturing apparatus to which catalyst regeneration equipment according to one embodiment of the present invention is applied, in which FIG. 1A is a longitudinal cross-sectional view of the reactor, and FIG. 1B is a transverse cross-sectional view of the reactor. In addition, FIG. 2 is a block diagram illustrating a configuration of the product manufacturing apparatus.

As illustrated in FIGS. 1A, 1B and 2, a product manufacturing apparatus 1 includes: a reactor 3, which includes a plurality of reaction tubes 2 each being filled with a predetermined catalyst C; a plurality of temperature sensors 4, each of which is provided for every reaction tube 2, and detects the temperature of the catalyst C in each reaction tube 2; a source gas introduction unit 5 for introducing a predetermined source gas into the reactor 3; a regeneration gas supply unit 6 for supplying every reaction tube 2 with a predetermined regeneration gas; and a controller 7, which controls the source gas introduction unit 5, the regeneration gas supply unit 6, and the like.

In the above reactor 3, a predetermined source gas (for example, a mixed gas of H₂ (hydrogen) and CO (carbon monoxide) or CO₂ (carbon dioxide)) is introduced, and useful products such as hydrocarbons and alcohol are manufactured while an exothermic reaction is generated in its inside.

As the catalyst C, depending on the source gas and the product, a material (Fe (iron), Zr (zirconium), Ga (gallium), and/or Na (sodium)) that promotes a reaction in producing the product is adopted. In addition, the catalyst C is formed into a pellet shape or the like each having a predetermined size.

As illustrated in FIGS. 1A and 1B, the reactor 3 includes a casing 11, which has a cylindrical shape extending in an up-down direction, and the above plurality of reaction tubes 2 are disposed in the casing 11. Specifically, as illustrated in FIG. 1B, a single reaction tube 2 is disposed in the central portion of the casing 11, and a plurality of reaction tubes 2 are disposed radially from the central portion of the casing 11. Note that although not illustrated, a control refrigerant for controlling the temperature of the reaction that occurs in each reaction tube 2 is configured to flow between the reaction tubes 2, which are adjacent to each other.

Each reaction tube 2 has a predetermined diameter, and is formed in a cylindrical shape extending for a predetermined length between an upstream side and a downstream side of the reactor 3 (the up-down direction in FIG. 1A), and the catalyst C is filled in its inside. In addition, in each reaction tube 2, the above temperature sensor 4 is disposed to extend along a length direction of the reaction tube 2. Each temperature sensor 4 includes a plurality of (five in the present embodiment) sensor elements 4a, which are disposed to be spaced apart at a predetermined interval from each other in a length direction, and each sensor element 4a detects the temperature of the catalyst C in the length direction in the reaction tube 2.

Further, the reactor 3 also includes an upper wall portion 12 in an upper end portion of the casing 11 so as to close it. A source gas introduction port 12a for introducing the source gas into the reactor 3 is provided in a central portion of such an upper wall portion 12.

Furthermore, the reactor 3 includes a lower wall portion 13 in a lower end portion of the casing 11 so as to close it. On such a lower wall portion 13, a post-reaction gas discharge port 13a for discharging the gas after reaction is provided in its central portion, and a product outlet port 13b for carrying out the product is provided in a predetermined position to be shifted in the radial direction from the central portion and to be different from the post-reaction gas discharge port 13a.

A supply pipe 21 of the regeneration gas supply unit 6 is provided on the upstream side of the reaction tube 2 in the reactor 3. Such a supply pipe 21 supplies every reaction tube 2 with the regeneration gas supplied from the outside of the reactor 3. The supply pipe 21 includes a plurality of discharge ports 22, which respectively correspond to the plurality of reaction tubes 2 to discharge the regeneration gas. In addition, a valve 23, which is controlled to open and close by the above-described controller 7, is provided at each discharge port 22.

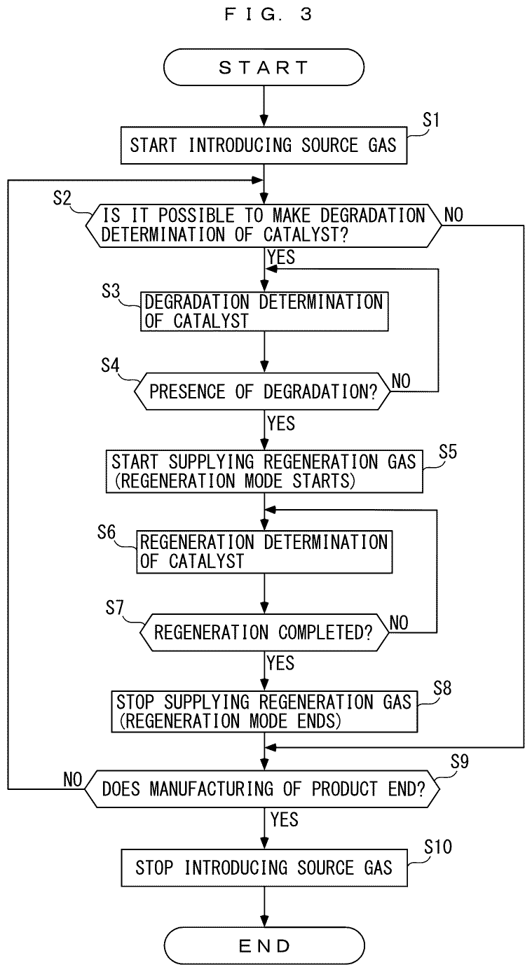

FIG. 3 is a flowchart at the time of manufacturing a product in the product manufacturing apparatus 1, and includes a regeneration mode for regenerating the degraded catalyst C at the time of manufacturing the product. As illustrated in the drawing, in manufacturing a predetermined product (for example, hydrocarbon) in the product manufacturing apparatus 1, first, step 1 (indicated as “S1”, and hereinafter, indicated in a similar manner), a predetermined source gas, specifically, a source gas that is a mixed gas of H₂ and CO₂ starts to be introduced into the reactor 3. In this case, the source gas is introduced into the reactor 3 through the source gas introduction port 12a of the reactor 3. The introduced source gas flows from an upper end to a lower end of each reaction tube 2. In this case, the source gas flowing in the reaction tube 2 comes into contact with the catalyst C, and a hydrocarbon is produced by the catalytic action. Then, the produced hydrocarbon is carried out to the outside through the product outlet port 13b, which is provided on the lower wall portion 13 of the reactor 3. Note that the post-reaction gas that remains in the reactor 3 is discharged to the outside through the post-reaction gas discharge port 13a, which is provided on the lower wall portion 13 of the reactor 3.

Next, in step 2, it is determined whether it is possible to make degradation determination of the catalyst C. Specifically, it is determined whether a condition for making the degradation determination of the catalyst C is satisfied, such as the temperature of the catalyst C in each reaction tube 2 being equal to or higher than a predetermined temperature. In a case where its determination result is NO, the condition for the degradation determination of the catalyst C is not satisfied, and it is not possible to make the degradation determination of the catalyst C, processing skips steps 3 to 8 to be described later and proceeds to step 9, the degradation determination of the catalyst C is not made, and the source gas is continuously supplied (step 9: NO).

On the other hand, in a case where the determination result in step 2 is YES and it is possible to make the degradation determination of the catalyst C, the processing proceeds to step 3, and the degradation determination of the catalyst C is made. In the degradation determination of the catalyst C, which catalyst C in the reaction tube 2 is degraded and the degradation degree of the degraded catalyst C are determined, based on a detection result of the temperature sensor 4 of each reaction tube 2.

Specifically, the degradation of the catalyst C is determined, in a case where a deviation Td (=Ta−Tc) between an appropriate temperature (hereinafter, referred to as “appropriate temperature Ta”) of the catalyst C at the time of producing a product in the reaction tube 2 and the temperature (hereinafter, “detection temperature Tc”) of the catalyst C that has been detected by the temperature sensor 4 in the reaction tube 2 exceeds a predetermined threshold, or a ratio (Td/Ta) of the above deviation Td to the appropriate temperature Ta exceeds a predetermined threshold.

In addition, as the detection result of the above-described temperature sensor 4, it is also possible to determine the degradation degree of the catalyst C by using any of the detection values of the plurality of sensor elements 4a or using an average value or a deviation of the detection values.

In a case where the presence of the degradation in the catalyst C in any of the reaction tubes 2 is determined by the above-described degradation determination (step 4:
YES), the regeneration mode of the catalyst C is started. Specifically, the supply of a predetermined regeneration gas is started for the reaction tube 2 including the catalyst C, in which the presence of the degradation has been determined (step 5).

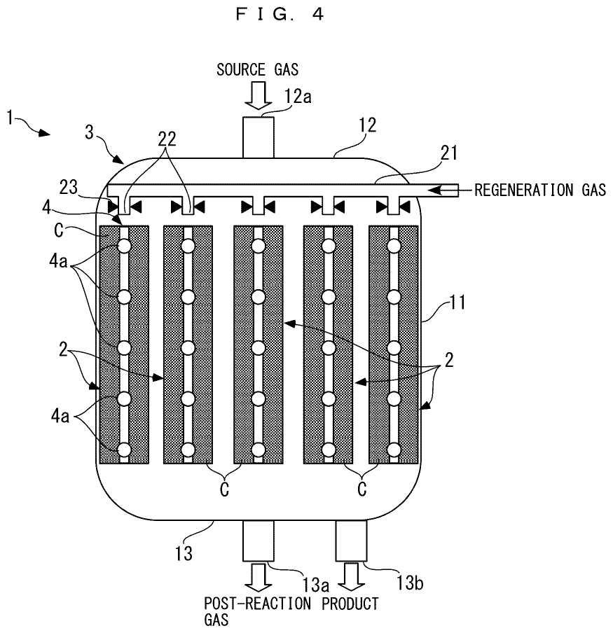

FIG. 4 is a diagram for describing the regeneration mode of the catalyst C in the reactor 3 at the time of manufacturing the product. As illustrated in the drawing, in the regeneration mode, the regeneration gas is supplied to the supply pipe 21 from the outside of the reactor 3. Then, the valve 23 of the discharge port 22, which corresponds to the reaction tube 2 including the degraded catalyst C, is opened, and the regeneration gas is discharged from the discharge port 22.

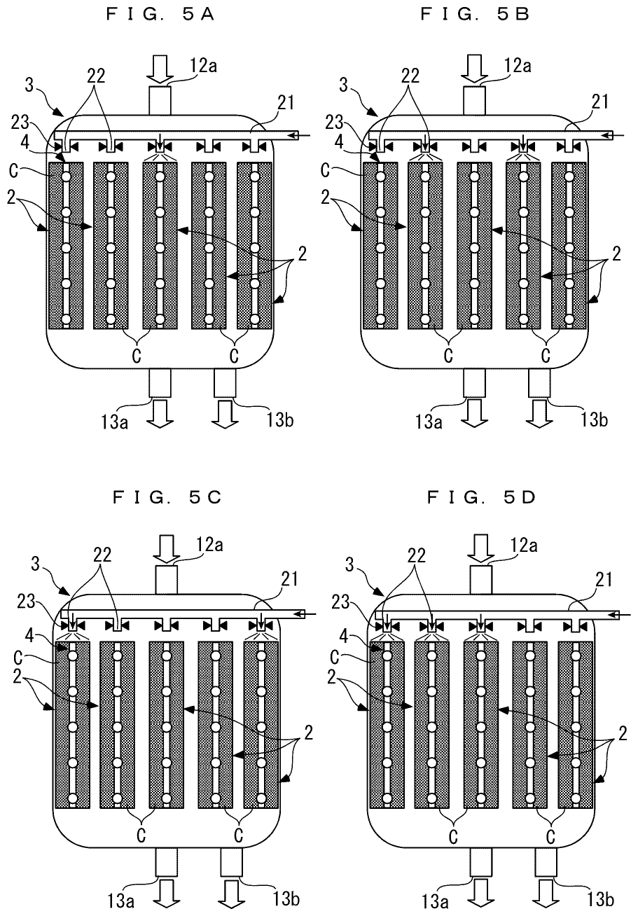

FIGS. 5A to 5D illustrate discharge patterns of the regeneration gas from the plurality of discharge ports 22 of the supply pipe 21. For example, FIG. 5A illustrates a state in which the regeneration gas is discharged from a single discharge port 22 located at the center of the supply pipe 21, and is supplied to an upper end portion of the reaction tube 2, which is disposed at the center of the reactor 3. In addition, FIG. 5B illustrates a state in which the regeneration gas is discharged from two discharge ports 22 each being adjacent to the discharge port 22 at the center of the supply pipe 21, and is supplied to the upper end portions of the corresponding reaction tubes 2. Further, FIG. 5C illustrates a state in which the regeneration gas is discharged from two discharge ports 22 each being located on an outermost side of the supply pipe 21, and is supplied to the upper end portions of the corresponding reaction tubes 2. Furthermore, FIG. 5D illustrates a state in which the regeneration gas is discharged from three discharge ports 22, which are located on the center of the supply pipe 21 and on its left side, and is supplied to the upper end portions of the corresponding reaction tubes 2.

Note that each of the above-described discharge patterns of the regeneration gas is merely one example, and the discharge pattern of the regeneration gas in the regeneration mode is not limited to them.

The above regeneration gas is supplied to the reaction tube 2 including the degraded catalyst C in order to remove the carbon deposited on the surface of the catalyst C in each reaction tube 2, and for example, the following gas is adopted.

For example, in a case where an oxidizing gas containing oxygen (O₂) is adopted as the regeneration gas, the carbon (C) deposited on the surface of the catalyst C reacts as follows, and is removed from the catalyst C.

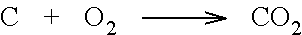

In addition, in a case where the reducing gas containing hydrogen (H₂) is adopted as the regeneration gas, the carbon deposited on the surface of the catalyst C reacts as follows, and is removed from the catalyst C. However, “n” in the following formula denotes an integer.

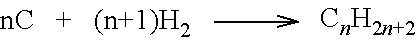

Furthermore, in a case where a vapor gas containing water vapor (H₂O) is adopted as the regeneration gas, the carbon deposited on the surface of the catalyst C reacts as follows, and is removed from the catalyst C.

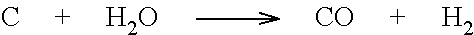

With regard to the regeneration gas supplied to the reaction tube 2 including the degraded catalyst C, the flow rate is set to increase, as the deviation Td between the appropriate temperature Ta of the catalyst C at the time of producing the product in the reaction tube 2 and the detection temperature Tc of the catalyst C that has been detected by the temperature sensor 4 in the reaction tube 2 increases. As the deviation Td increases, the degradation degree of the catalyst C increases. Therefore, the flow rate of the regeneration gas increases, as the degradation degree of the catalyst C increases, and thus the catalyst C can be regenerated appropriately in accordance with the degradation degree of the catalyst C.

Returning to FIG. 3, in step 6 that is subsequent to step 5, the regeneration determination of the catalyst C is made. The regeneration determination of the catalyst C is made, based on a detection result of the temperature sensor 4 of the reaction tube 2 to which the regeneration gas has been supplied.

Specifically, it is determined that the catalyst C has been regenerated, when the detection temperature Tc of the catalyst C that has decreased due to the degradation increases to a predetermined temperature near the appropriate temperature Ta, when the detection temperature Tc increases exceeding the appropriate temperature Ta and then decreases to the appropriate temperature Ta, when the deviation Td decreases below a predetermined threshold, or when the ratio of the deviation Td to the appropriate temperature Ta decreases below a threshold.

By the above-described regeneration determination, in a case where it is determined that the regeneration has been completed for the catalyst C in the reaction tube 2 to which the regeneration gas has been supplied (step 7: YES), the supply of the regeneration gas is stopped, and the regeneration mode ends (step 8).

Next, in step 9, it is determined whether manufacturing of the product ends in the product manufacturing apparatus 1. In a case where a determination result is NO and the manufacturing of the product continues, the above-described steps 2 to 8 are performed to repeat the degradation determination and the regeneration mode of the catalyst C. On the other hand, in a case where the determination result of step 9 is YES and the manufacturing of the product ends, the introduction of the source gas into the reactor 3 is stopped (step 10), and the manufacturing of the product is stopped.

As described heretofore, according to the present embodiment, when manufacturing a predetermined product through the catalytic action of the catalyst C in each reaction tube 2 by introducing a predetermined source gas into the reactor 3, the degradation of the catalyst C is determined, and the predetermined regeneration gas is supplied in a pinpointed manner to the reaction tube 2 including the degraded catalyst C. This enables regeneration of the degraded catalyst C in the catalysts C accommodated in the reactors 3 in a pinpointed manner, while the product is being continuously manufactured by the source gas that is continuously introduced into the reactor 3, and thus enables the regeneration of the degraded catalyst C, while a decrease in manufacturing efficiency is being suppressed at the time of manufacturing the product.

Note that the present invention is not limited to the above embodiments that have been described, and can be implemented in various modes. For example, in an embodiment, the mixed gas of H₂ and CO or CO₂ has been given as an example of the source gas. Fe, Zr, Ga, and/or Na have been given as examples of the catalyst C. An oxidizing gas, a reducing gas, and water vapor have been given as examples of the regeneration gas. However, the source gas, the catalyst, and the regeneration gas in the present invention are not limited to them, any source gas and any catalyst corresponding to a product that should be manufactured can be adopted, and any regeneration gas corresponding to degradation of the catalyst can be adopted.

In addition, in an embodiment, the temperature of the catalyst C in each reaction tube 2 has been used for determining the degradation and the regeneration of the catalyst C. Alternatively or additionally, any other appropriate determination index at the time of producing a product in the reactor 3 can be used. For example, as such a determination index, it is possible to use a gas flow rate, a gas composition, a gas temperature, a gas specific gravity, gas specific heat, gas viscosity, a temperature after cooling the gas of the post-reaction gas discharged from the reactor 3, a composition, a producing speed, viscosity, or a specific gravity of the product carried out of the reactor 3.

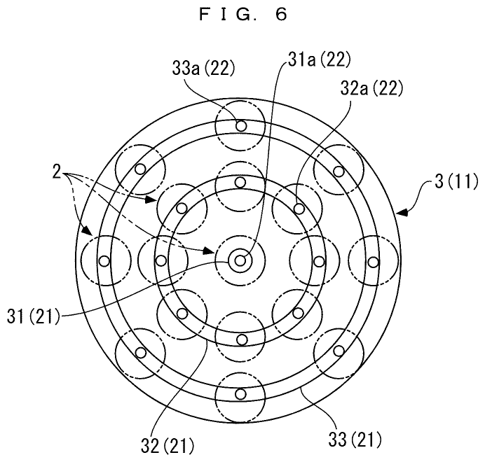

Furthermore, it is also possible to install the supply pipe 21 for supplying the regeneration gas in accordance with the arrangement of the plurality of reaction tubes 2 in the reactor 3. FIG. 6 illustrates one example of the supply pipe 21 installed in the reactor 3. The drawing illustrates three supply pipes 31, 32, and 33. Specifically, the supply pipe 21 includes: a first supply pipe 31, which has a circular shape, which is disposed in a central portion in a transverse cross-section of the reactor 3, and which has a planar shape with a predetermined diameter; a second supply pipe 32, which has a ring shape (ring-shaped supply pipe), which is disposed outside in the radial direction of the first supply pipe 31, and which has a planar shape with a predetermined diameter; and a third supply pipe 33, which has a ring shape (ring-shaped supply pipe), which is disposed outside in the radial direction of the second supply pipe 32, and which has a planar shape with a predetermined diameter. In the above first to third supply pipes 31 to 33, the second supply pipe 32 and the third supply pipe 33 are configured to be concentric around the first supply pipe 31. In addition, as the discharge port 22 for discharging the regeneration gas, the first supply pipe 31 has a single discharge port 31a, and the second supply pipe 32 and the third supply pipe 33 respectively have a plurality of (eight in FIG. 6) discharge ports 32a and a plurality of (eight in FIG. 6) discharge ports 33a. Note that the first to third supply pipes 31 to 33 are connected with one another, and the regeneration gas is supplied from the outside.

On the other hand, the plurality of reaction tubes 2, which are radially disposed in the reactor 3, are also disposed to be concentric around the reaction tube 2 in the central portion, and respectively correspond to the plurality of discharge ports 31a to 33a of the above-described first to third supply pipes 31 to 33. When the source gas is introduced into the reactor 3 including the reaction tubes 2 disposed as described above, the degrees of degradation may be similar to each other in the catalysts C in the plurality of reaction tubes 2 having the same distance from the central portion of the reactor 3. Therefore, by flowing the regeneration gas into the second supply pipe 32 or the third supply pipe 33, the regeneration gas can be simultaneously supplied to the plurality of reaction tubes 2, which are respectively disposed at equal distances from the central portion of the reactor 3, so that the catalyst C in these reaction tubes 2 can be efficiently regenerated.

Note that the above-described first to third supply pipes 31 to 33 are one example of the supply pipe 21 for supplying the regeneration gas, and various shapes can be adopted as long as it is possible to supply each reaction tube 2 in the reactor 3 with the regeneration gas appropriately. For example, the above second supply pipe 32 and the above third supply pipe 33 each have a ring planar shape, but may have, for example, a letter C shape instead of a perfect annular planar shape.

In addition, the detailed configurations of the reaction tube 2, the reactor 3, the temperature sensor 4, the source gas introduction unit 5, the regeneration gas supply unit 6, and the controller 7 that have been described in embodiments are merely examples, and can be appropriately changed within the scope of the gist of the present invention.

What is claimed is:

1. Catalyst regeneration equipment for regenerating a catalyst that has been degraded due to a catalytic action, while a predetermined source gas is being continuously introduced, in a reactor including a plurality of reaction tubes each being filled with the catalyst, the reactor generating a predetermined product through the catalytic action of the catalyst in each of the plurality of reaction tubes, the catalyst regeneration equipment comprising:
a catalyst degradation detection unit configured to detect presence or absence of degradation of the catalyst in every one of the plurality of reaction tubes;
a regeneration gas supply unit capable of supplying a predetermined regeneration gas for regenerating a degraded catalyst to every one of the plurality of reaction tubes; and
a controller configured to control the regeneration gas supply unit to supply the regeneration gas to a reaction tube including the catalyst in which the degradation has been detected, based on a detection result by the catalyst degradation detection unit.

2. The catalyst regeneration equipment according to claim 1, wherein the catalyst degradation detection unit includes a plurality of temperature sensors respectively provided in the plurality of reaction tubes, and configured to respectively detect temperatures of the catalysts in the plurality of reaction tubes.

3. The catalyst regeneration equipment according to claim 2, wherein each of the plurality of reaction tubes is configured to extend between an upstream side and a downstream side of the reactor, and
the plurality of temperature sensors each include a plurality of sensor elements disposed to be spaced apart at a predetermined interval from each other along a length direction of each of the plurality of reaction tubes.

4. The catalyst regeneration equipment according to claim 2, wherein the controller is configured to be capable of adjusting a flow rate of the regeneration gas supplied by the regeneration gas supply unit.

5. The catalyst regeneration equipment according to claim 4, wherein the controller adjusts and increases the flow rate of the regeneration gas, as a deviation between an appropriate temperature of the catalyst when the predetermined product is produced and the temperature that has been detected by the temperature sensor increases.

6. The catalyst regeneration equipment according to claim 1, wherein
the plurality of reaction tubes are each configured to extend between an upstream side and a downstream side of the reactor, and are disposed radially from a central portion of the reactor, and
the regeneration gas supply unit includes:
a plurality of ring-shaped supply tubes disposed on the upstream side of the plurality of reaction tubes in the reactor, and configured to be concentric around a central portion of the reactor; and
a plurality of discharge ports respectively disposed in the plurality of ring-shaped supply tubes along a circumferential direction, and configured to discharge the regeneration gas respectively to the plurality of reaction tubes.

7. A catalyst regeneration method for regenerating a catalyst that has been degraded due to a catalytic action, while a predetermined source gas is being continuously introduced, in a reactor including a plurality of reaction tubes each being filled with the catalyst, the reactor generating a predetermined product through the catalytic action of the catalyst in each of the plurality of reaction tubes, the catalyst regeneration method comprising:
a catalyst degradation determination process of determining presence or absence of degradation of catalysts in the plurality of reaction tubes; and
a catalyst regeneration process of supplying a predetermined regeneration gas for regenerating a degraded catalyst to a reaction tube including the catalyst in which the degradation has been detected.
